(19) United States
(12) Patent Application Publication
(10) Pub. No.: US 2023/0239021 A1
(43) Pub. Date: Jul. 27, 2023

(54) COMPUTATIONALLY EFFICIENT DIRECTIONAL SPECTRAL ESTIMATION FOR MULTI-USER MIMO PAIRING

(71) Applicant: Telefonaktiebolaget LM Ericsson (publ), Stockholm (SE)

(72) Inventors: Amr EL-KEYI, Kanata (CA); Chandra BONTU, Nepean (CA)

(21) Appl. No.: 18/004,128

(22) PCT Filed: Jul. 20, 2020
(86) PCT No.: PCT/IB2020/056804

§ 371 Date: Jan. 3, 2023

(51) Int. Cl. H04B 7/06; H04B 7/0452; H04L 25/02

(52) U.S. Cl. CPC H04B 7/0617; H04B 7/0452; H04L 25/021; H04L 25/0248

(57) ABSTRACT

According to one aspect, a network node is provided. The network node including processing circuitry configured to: estimate a spatial spectrum associated with a plurality of wireless devices, determine active spatial directions for the plurality of wireless devices based at least on the estimated spatial spectrum, and determine Multiple User-Multiple Input Multiple Output, MU-MIMO, pairing based at least on the determined active spatial directions.

### TECHNICAL FIELD

Wireless communication and in particular, spatial spectrum-based selection for pairing wireless devices for Multiple User-Multiple Input Multiple Output (MU-MIMO).

### BACKGROUND

Massive MIMO transmission is one enabling technology for 3^{rd} Generation Partnership Project (3GPP) 5^{th} Generation (5G, also referred to as New Radio (NR)) communication systems that enables enhanced spectral efficiency via spatial multiplexing. In order to benefit from the massive number of elements at a network node, suitable beamformers may be used for downlink transmission and uplink reception. In addition, the spatially multiplexed wireless devices may need to be selected properly. Careful selection of the beamforming vectors can reduce (or eliminate) mutual interference among different transmission layers by taking advantage of the spatial separation between the wireless devices, and hence, multiple wireless devices can be simultaneously supported via space-division multiple access. In addition, when the number of wireless devices is large, the network node can schedule its transmission to those wireless devices with favorable channel conditions by choosing a multiuser (MU)-MIMO user group with good spatial separation to improve the system throughput. This is commonly referred to as multiuser diversity.

Channel orthogonality has been proposed as a metric of determining whether the wireless devices have enough spatial separation for MU-MIMO grouping. A channel orthogonality test may require computing the average (over different subbands) correlation coefficient between the estimates of the channels of different wireless devices. In order to reduce the computational complexity of the channel orthogonality test when the number of subbands is large, the channel orthogonality metric can be evaluated using channel samples from one subband or few selected subbands which results in some performance degradation.

Further, several methods have been proposed for estimating the directions of arrival of multiple signals impinging on an antenna array of a network node. The Capon spectral estimation method allows not only estimating the angles of arrival of the signals but also the determining of the power received from each spatial direction. The angle of arrival and the power spectrum information can provide computationally efficient metrics for selecting the paired wireless devices in a MU-MIMO group. However, although the computational complexity of Capon estimation is much lower than that of many high-resolution spectral estimation methods, e.g., maximum likelihood estimation, the Capon estimation requires the inversion of the full covariance matrix of the channel estimate which may have a computational complexity that can be prohibitive especially when the number of antenna elements at the network node is large.

Some existing systems may suffer from one or more of the following disadvantages:
The typically channel orthogonality metric may require averaging over many frequency subbands. This averaging might be computationally expensive when the bandwidth is large such as in, for example, NR. Further, computing the channel orthogonality metric from a limited number of frequency samples can lead to performance degradation especially in fading channels with small coherence bandwidth.
Using existing methods for directional power spectrum estimation (e.g., periodogram) provides low resolution estimates that disadvantageously suffer from leakage effects. On the other hand, high resolution spectral estimation methods such as Capon's method have larger computational complexity that is cubic with respect to the number of antennas at the network node, thereby possibly making such methods hard to implement in real life configurations.
Existing solutions for wireless device pairing are based on performing a sequence of channel orthogonality tests based on the priority of the wireless devices. This approach can be further improved to increase the number of paired wireless devices and the total throughput by ordering the wireless devices based on additional performance-related metrics as well as their priority. Existing solutions are highly complex as a channel orthogonality test requires averaging over several subbands. Even though subband sampling of channel orthogonality test can be done to reduce the complexity, it results in some performance degradation. Limiting the pairing algorithm by considering the users based on their priority may also disadvantageously degrade the overall cell throughput. A high priority user might be spatially close to many UEs. Adding this user to the group might prevent pairing these UEs.

### SUMMARY

Some embodiments advantageously provide a method and system for spatial spectrum-based selection for pairing wireless devices for MU-MIMO.

In one or more embodiments, low complexity directional spectrum-based algorithms are provided for selecting wireless devices for pairing for MU-MIMO transmission. The spatial spectrum can be obtained by filtering the peridogram-based spectrum or using Capon spectral estimation. In order to reduce the complexity of the Capon spectral estimate, subspace tracking is used to provide an iterative estimate of the dominant eigen vectors and the associated eigen values of the signal space of the wireless device channel. The estimated signal space can be used to compute the Capon spectrum with low computational complexity. In particular, the computational complexity of the spectral estimation described herein is linear with respect to the number of antennas at the network node as opposed to existing methods that may be cubic (complexity-wise) with respect to the number of antennas at the network node. Further, while some existing methods rely on a per-subband channel correlation metric indicate the correlation between channels, one or more embodiments described herein rely on a wideband spatial correlation metric.

In one or more embodiments, two iterative algorithms that utilize the low complexity computation of the spatial spectrum are used for performing MU-MIMO pairing decisions. In the first algorithm, a wideband correlation coefficient of the computed spatial spectrum is used to determine the spatial separability of the wireless devices. In the second algorithm, a more computationally efficient algorithm is provided that retains only the dominant spatial directions in the spatial spectrum where the wireless devices are paired based on the degree of overlap between their dominant spatial directions. Simulation results illustrates that a 20% gain in cell throughput can be achieved using the algorithms described herein when compared to legacy channel orthogonality-based MU-MIMO group selection.

According to one aspect of the disclosure, a network node is provided. The network node includes processing circuitry configured to: estimate a spatial spectrum associated with a plurality of wireless devices; determine active spatial directions for the plurality of wireless devices based at least on the estimated spatial spectrum; and determine Multiple User-Multiple Input Multiple Output, MU-MIMO, pairing based at least on the determined active spatial directions.

According to one or more embodiments of this aspect, the estimate of the spatial spectrum includes: computing an instantaneous spatial spectrum; and temporal filtering of the instantaneous spatial spectrum, the estimated spatial spectrum being based at least on the temporal filtering. According to one or more embodiments of this aspect, the estimate of the spatial spectrum includes: estimating a covariance matrix of a channel by tracking a subset of eigen vectors of the covariance matrix where the estimate of the spatial spectrum is based on the estimated covariance matrix. According to one or more embodiments of this aspect, the subset of eigen vectors are dominant eigen vectors of the covariance matrix that are associated with higher eigen values than the remaining eigen vectors of the covariance matrix.

According to one or more embodiments of this aspect, each of the active spatial directions for the plurality of wireless devices meets a predefined received power threshold. According to one or more embodiments of this aspect, the active spatial directions correspond to a minimum number of spatial directions that meet a predefined received power threshold. According to one or more embodiments of this aspect, the processing circuitry is further configured to: determine a pairwise spectrum correlation metric for each wireless device of the plurality of wireless devices with respect to each of the plurality of wireless devices where the plurality of wireless device corresponds to a candidate MU-MIMO group; determine whether each pairwise spectrum correlation metric meets a predefined threshold; and add each wireless device associated with the pairwise spectrum correlation metric meeting the predefined threshold to a MU-MIMO group of wireless devices where the determined MIMO pairing is based at least on the MU-MIMO group of wireless devices.

According to one or more embodiments of this aspect, the pairwise spectrum correlation metric is non-negative and based at least on wideband channel information. According to one or more embodiments of this aspect, the processing circuitry is further configured to: determine a group paring metric for each wireless device in the candidate MU-MIMO group with respect to the MU-MIMO group of wireless devices; and select a wireless device to include in a MU-MIMO group of wireless devices based on the group pairing metric where the determined MIMO pairing is based at least on the MU-MIMO group. According to one or more embodiments of this aspect, the processing circuitry is further configured to: determine a spatial directions overlap metric for each wireless device of the plurality of wireless devices with respect to a MU-MIMO group of wireless devices where the plurality of wireless devices corresponds to a candidate MU-MIMO group; determine whether the spatial directions overlap metric for each wireless device meets a predefined criteria; and add each wireless device associated with the spatial directions overlap metric meeting the predefined criteria to the MU-MIMO group of wireless devices where the determined MIMO pairing is based at least on the MU-MIMO group of wireless devices. According to one or more embodiments of this aspect, the processing circuitry is further configured to select a wireless device to include in the MU-MIMO group of wireless devices based on a respective priority of each wireless device in the candidate MU-MIMO group where the determined MIMO pairing is based at least on the MU-MIMO group.

According to another aspect of the disclosure, a method implemented by a network node is provided. A spatial spectrum associated with a plurality of wireless devices is estimated. Active spatial directions for the plurality of wireless devices are determined based at least on the estimated spatial spectrum. Multiple User-Multiple Input Multiple Output, MU-MIMO, pairing is determined based at least on the determined active spatial directions.

According to one or more embodiments of this aspect, the estimate of the spatial spectrum includes: computing an instantaneous spatial spectrum; and temporal filtering of the instantaneous spatial spectrum, the estimated spatial spectrum being based at least on the temporal filtering. According to one or more embodiments of this aspect, the estimate of the spatial spectrum includes: estimating a covariance matrix of a channel by tracking a subset of eigen vectors of the covariance matrix, the estimate of the spatial spectrum being based on the estimated covariance matrix. According to one or more embodiments of this aspect, the subset of eigen vectors are dominant eigen vectors of the covariance matrix that are associated with higher eigen values than the remaining eigen vectors of the covariance matrix.

According to one or more embodiments of this aspect, each of the active spatial directions for the plurality of wireless devices meets a predefined received power threshold. According to one or more embodiments of this aspect, the active spatial directions correspond to a minimum number of spatial directions that meet a predefined received power threshold. According to one or more embodiments of this aspect, a pairwise spectrum correlation metric is determined for each wireless device of the plurality of wireless devices with respect to each of the plurality of wireless devices where the plurality of wireless devices corresponds to a candidate MU-MIMO group. A determination is performed as to whether each pairwise spectrum correlation metric meets a predefined threshold. Each wireless device associated with the pairwise spectrum correlation metric meeting the predefined threshold is added to a MU-MIMO group of wireless devices, the determined MIMO pairing being based at least on the MU-MIMO group of wireless devices.

According to one or more embodiments of this aspect, the pairwise spectrum correlation metric is non-negative and based at least on wideband channel information. According to one or more embodiments of this aspect, a group paring metric is determined for each wireless device in the candidate MU-MIMO group with respect to the MU-MIMO group of wireless devices. A wireless device is selected to include in a MU-MIMO group of wireless devices based on the group pairing metric where the determined MIMO pairing is based at least on the MU-MIMO group. According to one or more embodiments of this aspect, a spatial directions overlap metric is determined for each wireless device of the plurality of wireless devices with respect to a MU-MIMO group of wireless devices where the plurality of wireless devices corresponds to a candidate MU-MIMO group. A determination is performed as to whether the spatial directions overlap metric for each wireless device meets a predefined criteria. Each wireless device associated with the spatial directions overlap metric meeting the predefined criteria is added to the MU-MIMO group of wireless devices where the determined MIMO pairing is based at least on the MU-MIMO group of wireless devices. According to one or more embodiments of this aspect, a wireless device is selected to include in the MU-MIMO group of wireless devices based on a respective priority of each wireless device in the candidate MU-MIMO group where the determined MIMO pairing is based at least on the MU-MIMO group.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a diagram of a uniformly spaced 2-dimensional polarized array according to some embodiments of the disclosure;

FIG. 9 is a diagram of a MU-MIMO pairing algorithm using subspace tracking based on directional spectrum information according to some embodiments of the disclosure;

FIG. 10 is a flow diagram of an example directional spectrum correlation-based pairing algorithm according to some embodiments of the disclosure;

FIG. 11 is a flow diagram of an example active spatial directions-based pairing algorithm according to some embodiments of the disclosure;

FIG. 12 is a diagram of simulation results of downlink cell throughput versus a number of wireless devices for several algorithms according to some embodiments of the disclosure; and

FIG. 13 is a diagram of simulation results of a number of MU-MIMO layers versus a number of wireless devices according to some embodiments of the disclosure.

### DETAILED DESCRIPTION

Before describing in detail example embodiments, it is noted that the embodiments reside primarily in combinations of apparatus components and processing steps related to spatial spectrum-based selection for pairing wireless devices for MU-MIMO. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide spatial spectrum-based selection for pairing wireless devices for MU-MIMO. As used herein, the term “pairing” may be used interchangeably with the term “co-scheduling”, and refers to the scheduling of two or more wireless devices to send and/or receive radio signals on a same set of time/frequency physical radio resources.

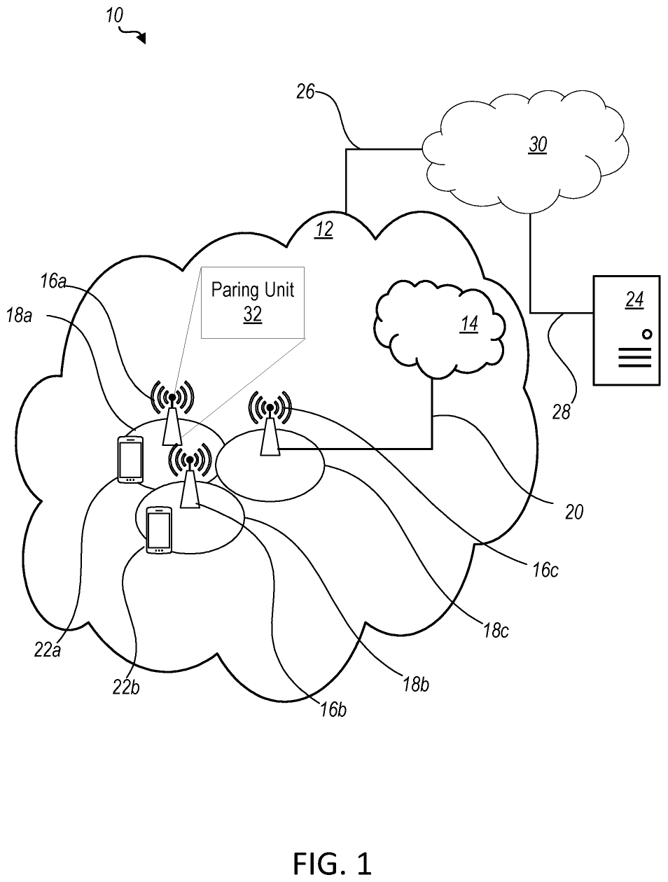

Referring now to the drawing figures, in which like elements are referred to by like reference numerals, there is shown in FIG. 1 a schematic diagram of an example communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NB s, eNB s, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a pairing unit 32 which is configured to perform one or more network nodes 16 functions as described herein such as with respect to spatial spectrum-based selection for pairing WDs 22 for MU-MIMO.

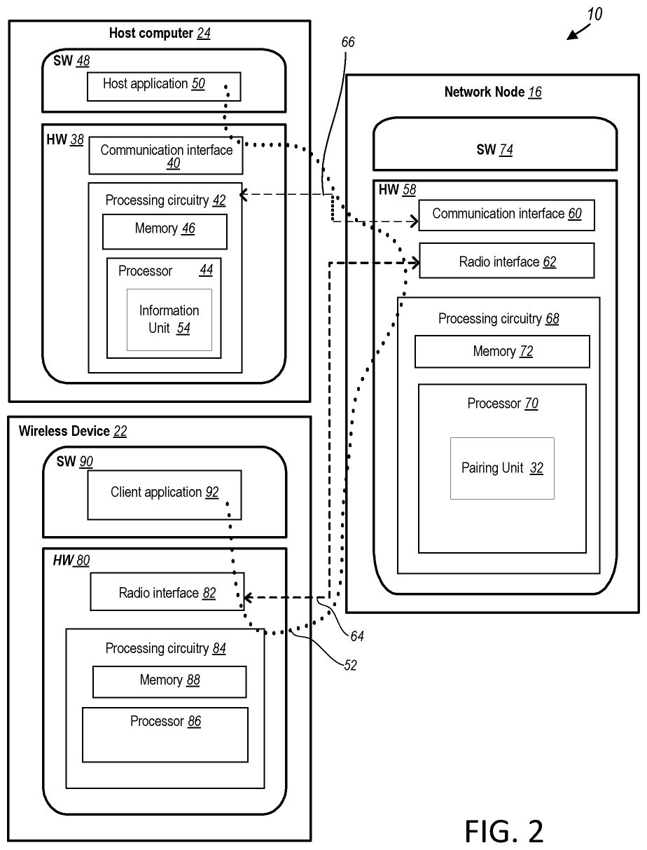

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to perform one or more of the following: determine, access, provide, transmit, receive, relay, forward, store, etc., information related to spatial spectrum-based selection for pairing wireless devices for MU-MIMO. For example, in one or more embodiments, one or more network node 16 functions described herein may instead be performed by host computer 24 where the result of one or more functions may be signaled to network node 16.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include pairing unit 32 configured to perform one or more network node 16 functions as described herein such as with respect to spatial spectrum-based selection for pairing wireless devices for MU-MIMO, as described herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as pairing unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

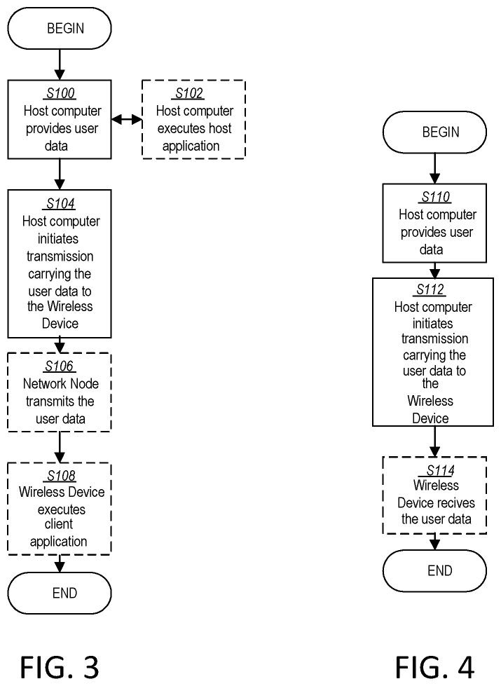

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

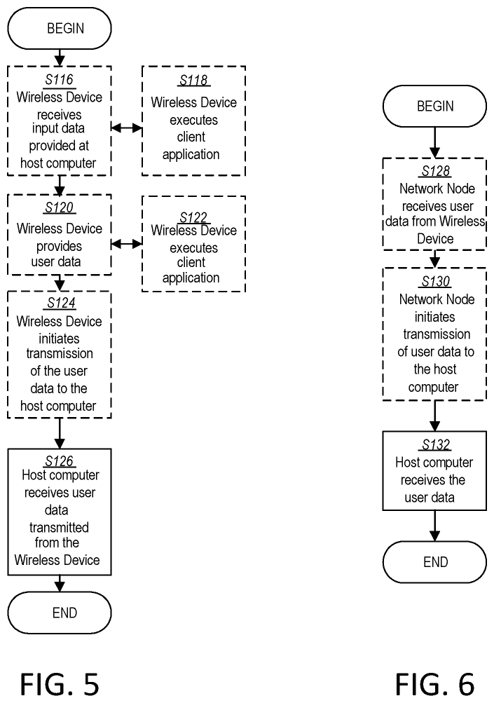

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

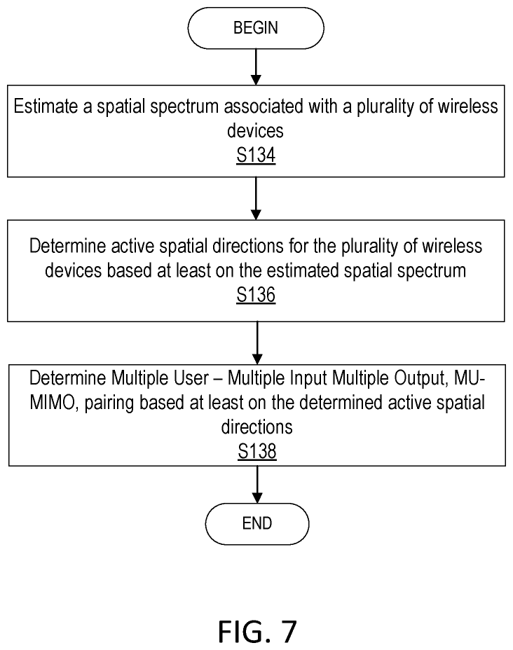

FIG. 7 is a flowchart of an example process in a network node 16 according to some embodiments of the present disclosure. One or more Blocks and/or functions performed by network node 16 may be performed by one or more elements of network node 16, such as by pairing unit 32 in processing circuitry 68, processor 70, radio interface 62, etc. In one or more embodiments, network node 16 such as via one or more of processing circuitry 68, processor 70, pairing unit 32, communication interface 60 and radio interface 62 is configured to estimate (Block S134) a spatial spectrum associated with a plurality of wireless devices 22, as described herein. In one or more embodiments, network node 16 such as via one or more of processing circuitry 68, processor 70, pairing unit 32, communication interface 60 and radio interface 62 is configured to determine (Block S136) active spatial directions for the plurality of wireless devices based at least on the estimated spatial spectrum, as described herein. In one or more embodiments, network node 16 such as via one or more of processing circuitry 68, processor 70, pairing unit 32, communication interface 60 and radio interface 62 is configured to determine (Block S138) Multiple User-Multiple Input Multiple Output, MU-MIMO, pairing based at least on the determined active spatial directions, as described herein.

According to one or more embodiments, the estimate of the spatial spectrum includes: computing an instantaneous spatial spectrum; and temporal filtering of the instantaneous spatial spectrum where the estimated spatial spectrum is based at least on the temporal filtering. According to one or more embodiments, the estimate of the spatial spectrum includes: estimating a covariance matrix of a channel by tracking a subset of eigen vectors of the covariance matrix where the estimate of the spatial spectrum is based on the estimated covariance matrix. According to one or more embodiments, the subset of eigen vectors are dominant eigen vectors of the covariance matrix that are associated with higher eigen values than the remaining eigen vectors of the covariance matrix.

According to one or more embodiments, each of the active spatial directions for the plurality of wireless devices meets a predefined received power threshold. According to one or more embodiments, the active spatial directions correspond to a minimum number of spatial directions that meet a predefined received power threshold. According to one or more embodiments, the processing circuitry 68 is further configured to: determine a pairwise spectrum correlation metric for each wireless device of the plurality of wireless devices with respect to each of the plurality of wireless devices where the plurality of wireless device 22 corresponds to a candidate MU-MIMO group; determine whether each pairwise spectrum correlation metric meets a predefined threshold; and add each wireless device associated with the pairwise spectrum correlation metric meeting the predefined threshold to a MU-MIMO group of wireless devices 22 where the determined MIMO pairing is based at least on the MU-MIMO group of wireless devices 22.

According to one or more embodiments, the pairwise spectrum correlation metric is non-negative and based at least on wideband channel information. According to one or more embodiments, the processing circuitry 68 is further configured to: determine a group paring metric for each wireless device 22 in the candidate MU-MIMO group with respect to the MU-MIMO group of wireless devices 22; and select a wireless device 22 to include in a MU-MIMO group of wireless devices 22 based on the group pairing metric, the determined MIMO pairing being based at least on the MU-MIMO group. According to one or more embodiments, the processing circuitry 68 is further configured to: determine a spatial directions overlap metric for each wireless device 22 of the plurality of wireless devices 22 with respect to a MU-MIMO group of wireless devices 22 where the plurality of wireless devices 22 corresponds to a candidate MU-MIMO group; determine whether the spatial directions overlap metric for each wireless device 22 meets a predefined criteria; and add each wireless device 22 associated with the spatial directions overlap metric meeting the predefined criteria to the MU-MIMO group of wireless devices 22 where the determined MIMO pairing is based at least on the MU-MIMO group of wireless devices 22. According to one or more embodiments, the processing circuitry 68 is further configured to select a wireless device 22 to include in the MU-MIMO group of wireless devices 22 based on a respective priority of each wireless device 22 in the candidate MU-MIMO group where the determined MIMO pairing is based at least on the MU-MIMO group.

Having generally described arrangements for spatial spectrum-based selection for pairing wireless devices for MU-MIMO, details for these arrangements, functions and processes are provided as follows, and which may be implemented by the network node 16, wireless device 22 and/or host computer 24.

Some embodiments provide spatial spectrum-based selection for pairing wireless devices for MU-MIMO.

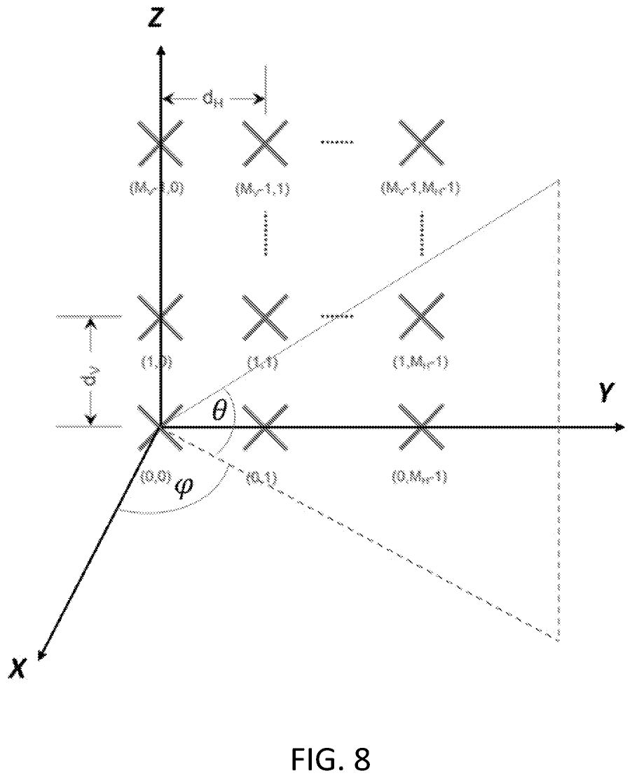

The following discussion assumes that network node 16 is employing a 2-dimensional polarized array placed along the Y-Z axes as shown in FIG. 8. Let M_{V} and M_{H} denote the number of rows and columns of the 2-dimensional antenna array, respectively, i.e., the total number of antenna elements is given by 2M_{V}M_{H}. The M_{V}×M_{H}×2 multi-dimensional matrix Hᵢ(f, t) is defined such that the (m, n, p) element of Hᵢ(f, t) is the ith wireless devices 22's coefficient of the channel associated with the antenna element of network node 16 in row m, column n and polarization p at time instant t and frequency subband f, where m=1, . . . , M_{V}, n=1, . . . , M_{H}, and p=0, 1. Furthermore, the 2M_{V}M_{H}×1 full channel vector associated with wireless device i is defined as

hᵢ(f,t)=[hᵢ⁽⁰⁾^{^{T}}(f,t),hᵢ⁽¹⁾^{^{T}}(f,t)]^{T}

where (·)^{T}, (·)^{H}, and (·)* denote the vector transpose, vector Hermitian transpose, and complex conjugate operators, respectively, hᵢ^{(p)}(f,t) is the M_{V}M_{H}×1 vector containing the coefficients of the channel associated with the antennas with polarization p, and hᵢ^{(p)}(f, t) can be obtained by applying the vectorization operator (that stacks the columns of a 2-dimensional matrix on top of each other) to the two-dimensional sub-matrix of Hᵢ(f, t) associated with polarization p.

In time-division duplex systems where channel reciprocity can be assumed, the channel estimates are available at the network node 16, e.g., from uplink channel sounding transmissions, and are used by the network node 16 to select beamforming coefficients to transmit downlink data to the wireless devices 22. In downlink MU-MIMO transmission mode, multiple wireless devices 22 can be co-scheduled such as via one or more of processing circuitry 68, processor 70, radio interface 62, pairing unit 32, etc., on the same resources and the downlink beamforming coefficients can be selected to suppress inter-user interference between the co-scheduled wireless devices 22. For example, when wireless device 22a and wireless device 22b are paired such as via one or more of processing circuitry 68, processor 70, radio interface 62, pairing unit 32, etc., in a MU-MIMO transmission with one-layer transmission per wireless device 22, the MU-MIMO beamformer at time instant t and frequency f is given by the 2M_{V}M_{H}×2 matrix

W(f,t)=H(f,t)^{H}(H(f,t)H^{H}(f,t)+δ²I₂)⁻¹

where

$$H ( f , t ) = [ \begin{matrix}{h}_{0}^{T} ( f , t ) \\ {h}_{1}^{T} ( f , t )\end{matrix} ] ,$$

I_{K} is the K×K identity matrix, and δ² is the interference-plus-noise estimate. Note that the term (H(f, t) H^{H}(f, t)+δ²I₂)⁻¹ in the above expression is responsible for suppressing the inter-wireless device interference while the term H(f, t)^{H} is equivalent to matched filtering beamforming in the directions of channels of the paired wireless devices 22. Expanding the expression for the MU-MIMO beamformer, results in the following

$$W ( f , t ) = {H ( f , t )}^{H} {( [ \begin{matrix}{h}_{0}^{T} ( f , t ) {h}_{0}^{*} ( f , t ) & {h}_{0}^{T} ( f , t ) {h}_{1}^{*} ( f , t ) \\ {h}_{1}^{T} ( f , t ) {h}_{0}^{*} ( f , t ) & {h}_{1}^{T} ( f , t ) {h}_{1}^{*} ( f , t )\end{matrix} ] + {δ}^{2} {I}_{2} )}^{- 1} .$$

Note that the off-diagonal term h₀^{T}(f, t)h₁*(f, t) results in SINR loss (compared to SU-MIMO transmission) due to inter-user interference suppression, i.e., if h₀^{T}(f, t)h₁*(f, t)=0 then there is no SINR loss due null steering and the MU-MIMO beamformer is equivalent to single user (SU)-MIMO beamforming for each wireless device. Therefore, a common metric for deciding whether wireless devices i and j can be paired in a MU-MIMO group is the channel orthogonality metric which is given by

$${ρ}_{H}^{( i , j )} ( t ) = \frac{1}{{N}_{f}} \frac{\vert {h}_{i}^{T} ( f , t ) {h}_{j}^{*} ( f , t ) \vert}{‖ {h}_{i} ( f , t ) ‖ ‖ {h}_{j} ( f , t ) ‖}$$

where N_{f} is the number of subbands used for MU-MIMO downlink transmission to wireless devices i and j. As used herein, wireless device i and wireless device j may correspond to wireless device 22. The channel orthogonality metric measures the average correlation of the channel coefficients. The computational complexity of evaluating ρ_{H}^{(i,j)}(t) is given by N_{f}(6M_{H}M_{V}+1) complex multiplications. In order to reduce the computational complexity of MU-MIMO pairing tests, the channel orthogonality metric can be evaluated using channel samples from one subband which results in some performance degradation. Typically, the metric ρ_{H}^{(i,j)}(t) is compared against a predetermined threshold γ_{H} and if ρ_{H}^{(i,j)}(t)<γ_{H}, then wireless devices i and j can be paired in a MU-MIMO group.

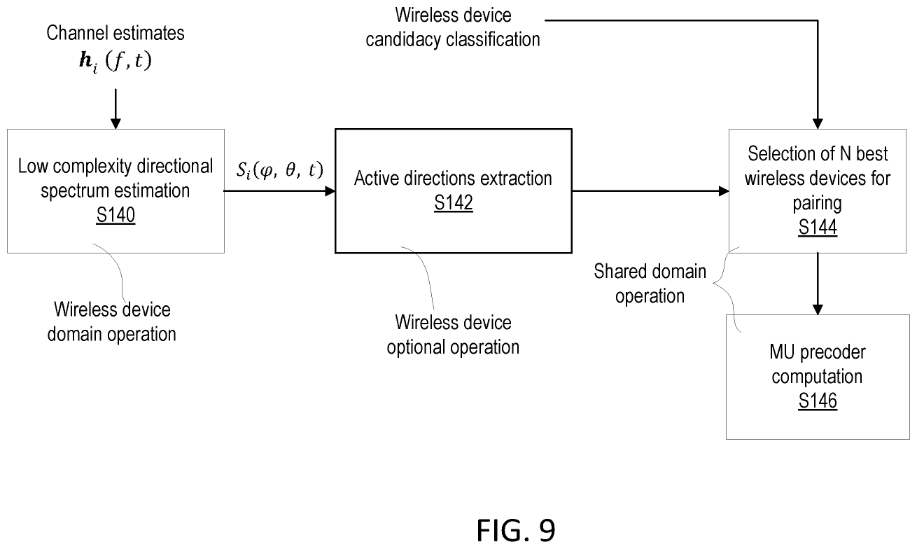

In one or more embodiments, the directional spectrum information is used, such as via one or more of processing circuitry 68, processor 70, radio interface 62, pairing unit 32, etc., to perform MU-MIMO pairing. FIG. 9 is a block diagram of an example MU-MIMO pairing algorithm. One or more Blocks and/or functions performed by network node 16 may be performed by one or more elements of network node 16 such as by pairing unit 32 in processing circuitry 68, processor 70, radio interface 62, etc. In one or more embodiments, network node 16, such as via one or more of processing circuitry 68, processor 70, pairing unit 32, communication interface 60 and radio interface 62 is configured to perform (Block S140) low complexity direction spectrum estimation such as based on channel estimates, as described herein. In one or more embodiments, network node 1, 6 such as via one or more of processing circuitry 68, processor 70, pairing unit 32, communication interface 60 and radio interface 62 is configured to perform (Block S142) active direction extraction, as described herein. In one or more embodiments, network node 16, such as via one or more of processing circuitry 68, processor 70, pairing unit 32, communication interface 60 and radio interface 62 is configured to perform (Block S144) selection of N best wireless devices for pairing such as based at least on the active directions extraction and a wireless device 22 candidacy classification, as described herein. In one or more embodiments, network node 16, such as via one or more of processing circuitry 68, processor 70, pairing unit 32, communication interface 60 and radio interface 62 is configured to perform (Block S146) MU precoder computation as described herein. Further details of the Blocks in FIG. 9 are provided below.

Instead of using the subband channel estimates to compute the channel orthogonality metric between different wireless devices 22, the MU-MIMO pairing algorithm utilizes, such as via one or more of processing circuitry 68, processor 70, radio interface 62, pairing unit 32, etc., the two-dimensional spatial spectrum {Sᵢ(φ, θ, t)}ᵢ in MU-MIMO pairing decisions where Sᵢ(φ, θ, t) is the estimate of the power received at wireless device i at time t from the azimuth direction φ and elevation direction θ.

Two example methods for evaluating the spatial spectrum are provided herein. The first method uses a filtered periodogram estimator to compute, such as via one or more of processing circuitry 68, processor 70, radio interface 62, pairing unit 32, etc., the power in each spatial direction. The second method uses a combination of subspace tracking and Capon spectral estimation. In particular, the Capon spatial spectrum is obtained, such as via one or more of processing circuitry 68, processor 70, radio interface 62, pairing unit 32, etc., by estimating the dominant eigen vectors and eigen values of the covariance matrix of the channel to wireless device i via a low complexity iterative subspace tracking algorithm that is updated every time new channel estimates are available.

The spatial spectrum can optionally be further processed, such as via one or more of processing circuitry 68, processor 70, radio interface 62, pairing unit 32, etc., to extract the set of active directions. In addition, wireless device 22 MU-MIMO candidacy classification may be performed for each wireless device 22 to filter MU-MIMO grouping candidates based at least on one or more of the following buffer status, channel quality, pathloss, channel variation rate, etc. Note that the above operations are performed in wireless device 22 domain, i.e., the operations/actions for the one or more methods are updated separately for each wireless device 22 at a rate much smaller than the scheduling interval. As shown in FIG. 9, the spatial spectrum and wireless device 22 MU candidacy classification information are used such as via one or more of processing circuitry 68, processor 70, radio interface 62, pairing unit 32, etc., to select the paired wireless devices 22 with low computational complexity and the MU-MIMO precoder is calculated for the paired wireless devices 22 only.

The functionality and the algorithms used in each block in FIG. 9 is described below.

Spatial Spectrum Estimation

Two algorithms for spatial spectrum estimation are described below. The first algorithm uses classical Periodgram-based estimation techniques with additional filtering in time-domain to compute, such as via one or more of processing circuitry 68, processor 70, radio interface 62, pairing unit 32, etc., the spatial spectrum. The second algorithm uses the high-resolution Capon spectral estimator to compute, such as via one or more of processing circuitry 68, processor 70, radio interface 62, pairing unit 32, etc., the spatial spectrum. However, instead of computing the Capon spectrum estimate from the channel covariance matrix, subspace tracking is advantageously employed to estimate a limited number of eigen vectors and the associated eigen values of the covariance matrix, i.e., only a partial portion of the covariance matrix may be used. The eigen vectors and values are then used directly to estimate the Capon spatial spectrum with reduced computational complexity.

Filtered Periodogram Spatial Spectrum Estimation

Given hᵢ^{(p)}(f, t), the estimate of the ith wireless device 22 channel associated with antenna polarization p at time t and frequency f is determined. The peridogram method starts by computing, such as via one or more of processing circuitry 68, processor 70, radio interface 62, pairing unit 32, etc., the instantaneous two-dimensional spatial spectrum S(φ, θ, t)

$${S}_{i} ( φ , θ , t ) = {\sum }_{f} {\sum }_{p = 0 , 1} {\vert {{h}_{i}^{( p )} ( f , t )}^{H} a ( φ , θ ) \vert}^{2}$$

where α(φ, θ) is the M_{V}M_{H}×1 vector containing the per-polarization array response for a waveform arriving from the (azimuth, elevation) direction (φ, θ). For the uniformly spaced linear two-dimensional array shown in FIG. 8, the entry of the array response vector corresponding to the antenna element in row m and column n of the array is given by

$$a ( φ , θ ) [ m , n ] = exp ( \sqrt{- 1} 2 π \frac{f}{c} ( {d}_{H} ( n - 1 ) sin ( φ ) cos ( θ ) + {d}_{V} ( m - 1 ) sin ( θ ) ) )$$

where f is the propagation frequency of the waveform, c is the propagation speed, and d_{H} and d_{V} are the array inter-element spacings in the horizontal and vertical directions respectively.

The periodogram can also be computed on any basis vectors, e.g., using Beamspace-transformed channel estimates. In this case, the channel estimates are transformed such as via one or more of processing circuitry 68, processor 70, radio interface 62, pairing unit 32, etc., to Beamspace using the M_{V}M_{H}×M_{V}M_{H} Beamspace transformation matrix B, i.e.,

\tilde{h}ᵢ^{(p)}(f,t)=B^{H}hᵢ^{(p)}(f,t)

where the Beamspace transformation matrix can be formed using any orthogonal basis. Typically, for the two-dimensional array shown in FIG. 8, a two-dimensional DFT basis is used where the Beamspace transformation matrix is given by

B=I₂⊗D_{H}⊗D_{V}

where D_{H} and D_{V} are respectively the M_{H}×M_{H} and M_{V}×M_{V} DFT matrices, i.e., the (m, k) element of D_{X} is given by

$$\frac{1}{\sqrt{{M}_{X}}} {e}^{j \frac{2 π mk}{{M}_{X}}} ,$$

where m, k=0, . . . , M_{X}−1 and ⊗ is the Kronecker product operator. In this case, the array response vector is computed in Beamspace and the spatial spectrum is given by

$${S}_{i} ( φ , θ , t ) = {\sum }_{f} {\sum }_{p = 0 , 1} {\vert {{\tilde{h}}_{i}^{( p )} ( f , t )}^{H} \tilde{a} ( φ , θ ) \vert}^{2} where$$

$$\tilde{a} ( φ , θ ) = {B}^{H} a ( φ , θ ) .$$

After computing the instantaneous spatial spectrum Sᵢ(φ, θ, t), Temporal filtering is applied to smooth the spatial spectrum. The filtered spectrum Sᵢ(φ, θ) is updated as

$${S}_{i} ( φ , θ ) = β {S}_{i} ( φ , θ ) + ( 1 - β ) {S}_{i} ( φ , θ , t )$$

$$where β = {e}^{- \frac{t - {t}_{0}}{{W}_{t}}} ,$$

t₀ is the time of last update of the filtered power per beam, and Wₜ is the effective memory length with can be selected to match the mobility of the wireless device 22.

Capon Spatial Spectrum Estimation

Two-Dimensional Subspace Tracking

Due to the similarity of the covariance matrices of channel associated with each set of polarized antennas, i.e.,

Σ{hᵢ⁽⁰⁾(t)hᵢ⁽⁰⁾^{^{H}}(t)}=E{hᵢ⁽¹⁾(t)hᵢ⁽¹⁾^{^{H}}(t)}=Rᵢ(t),

the signal subspace per antenna polarization may be tracked, i.e., the dominant (highest) R eigen values and the associated eigen vectors of the M_{V}M_{H}×M_{V}M_{H} matrix Rᵢ(t). Let λ_{i,j}(t) denote the jth eigen value of Rᵢ(t) where λ_{i,j}(t)≥λ_{i,k}(t) for j<k, and let e_{i,j}(t) denote the M_{V}M_{H}×1 dimensional eigen vector associated with λ_{i,j} (t). The projection approximation subspace tracking with deflation (PASTd) algorithm may be used to iteratively estimate the M_{V}M_{H}×R matrix Eᵢ(t)=[e_{i,0}(t), . . . , e_{i,R-1}(t)] and the corresponding matrix Λᵢ(t)=diag{λ_{i,0}(t), . . . , λ_{i,R-1}(t)} where R≤M_{V}M_{H}.

Let β denote the exponential window forgetting factor of the PASTd algorithm and \tilde{λ}_{i,k}(t−1) denote the exponentially weighed kth eigen value of wireless device i, i.e., λ_{i,k}(t−1)=(1−β)\tilde{λ}_{i,k}(t−1). Given {\tilde{λ}_{i,k}(t−1)}ₖ₌₀^{R-1} and {e_{i,k}(t−1)}ₖ₌₀^{R-1} from iteration t−1, and the new M_{H}M_{V}×1 per-polarization channel measurement hᵢ^{(p)}(f, t), one iteration of the PASTd algorithm is described below:
Initialize the deflated measurement

$${z}_{i , 0} ( t ) = \frac{{h}_{t}^{( p )} ( f , t )}{‖ {h}_{i}^{( p )} ( f , t ) ‖}$$

For k=0, . . . , R−1
   Compute the inner product y_{i,k}(t)=e_{i,k}^{H}(t−1)z_{i,k}(t)
   Update the estimate of the eigen value \tilde{λ}_{i,k}(t)=β\tilde{λ}_{i,k}(t−1)+|y_{i,k}(t)|²
   Compute the M_{H}M_{V}×1 innovation vector ν_{i,k}(t)=z_{i,k}(t)−e_{i,k}(t−1)y_{i,k}(t)
   Update the estimate of the eigen vector

$${e}_{i , k} ( t ) = {e}_{i , k} ( t - 1 ) + {v}_{i , k} ( t ) \frac{{y}_{i , k}^{⋆} ( t )}{{\tilde{λ}}_{i , k} ( t )}$$

Compute the deflated measurement z_{i,k+1}(t)=z_{i,k}(t)−e_{i,k}(t)y_{i,k}(t)
End For

Note that the computational complexity of processing one channel measurement hᵢ^{(p)}(f, t) to update the tracked signal subspace using the PASTd algorithm is given by 8M_{V}M_{H}R_{V}+4M_{V}M_{H}+2R complex multiplications. Furthermore, note that since the input channel measurement z_{i,0}(t) is normalized to have unit norm, then Σₖ₌₀^{M}^{_{V}}^{M}^{_{H}}λ_{i,k}(t)=1.

Subspace Tracking Based Capon Spectral Estimation

The Capon Spectrum computes the two-dimensional spatial spectrum Sᵢ(φ, θ, t) associated with wireless device i as

$${S}_{i} ( φ , θ , t ) = \frac{1}{{a}^{H} ( φ , θ ) {\hat{R}}_{i}^{- 1} ( t ) a ( φ , θ )}$$

where \hat{R}(t) is the estimate of the covariance matrix of the channel at time t. Given the M_{H}M_{V}×R orthonormal matrix Eᵢ(t) containing the estimates of the tracked Eigen vectors at time t, and the R×R diagonal matrix Λᵢ(t) containing the corresponding eigen values, it may be assumed that all the non-tracked eigen values have equal magnitude. Hence, \hat{R}(t) can be written as

\hat{R}ᵢm=Eᵢ(t)Λᵢ(t)Eᵢ^{H}(t)+σᵢ²(t)(I_{M}_{_{V}}_{M}_{_{H}}−Eᵢ(t)Eᵢ^{H}(t))

where σₜ²(t) is the power of each non-tracked eigen value; which is estimated as

$${σ}_{i}^{2} ( t ) = \frac{1}{{M}_{H} {M}_{V} - R} ( 1 - {\sum }_{k = 0}^{R - 1} {λ}_{i , k} ( t ) ) .$$

Using the matrix inversion lemma and the fact the tracked eigen vectors matrix is orthonormal, i.e., Eᵢ^{H}(t)Eᵢ(t)=I_{R}, the following results:

$${\hat{R}}_{i}^{- 1} ( t ) = {E}_{i} ( t ) ( {Λ}_{i}^{- 1} ( t ) - \frac{1}{{σ}_{i}^{2} ( t )} {I}_{R} ) {E}_{i}^{H} ( t ) + \frac{1}{{σ}_{i}^{2} ( t )} {I}_{{M}_{H} {M}_{V}} .$$

The Capon spectrum is therefore given by

$${S}_{i} ( φ , θ , t ) = \frac{1}{\begin{matrix}\frac{1}{{σ}_{i}^{2} ( t )} {‖ a ( φ , θ ) ‖}^{2} + \\ {\sum }_{k = 0}^{R - 1} ( \frac{1}{{λ}_{i , k} ( t )} - \frac{1}{{σ}_{i}^{2} ( t )} ) {\vert {e}_{i , k}^{H} ( t ) a ( φ , θ ) \vert}^{2}\end{matrix}}$$

which can be evaluated with computational complexity given by R((M_{H}M_{V}+2)) complex multiplications for each spatial grid point (φ, θ). Note that this computational complexity is much lower than the computational complexity of evaluating the Capon Spectrum through inversion of the covariance matrix as one or more embodiments described herein do not require the inversion of the covariance matrix. Furthermore, note that the Capon spectrum does not need to be filtered in time domain as the eigen vectors and eigen values are obtained through subspace tracking which has temporal memory due to using the forgetting factor β. Hence, for the Capon Estimator in one or more embodiments, results in

Sᵢ(φ,θ)=(φ,θ,t).

Therefore, in one or more embodiments, only a partial portion (i.e., eigen vectors and eigen values) of the covariance matrix is used for estimation, thereby reducing complexity by using an approximation of the covariance matrix.

Active Spatial Directions Selection

The normalized spatial spectrum \tilde{S}ᵢ(φ, θ) is obtained from Sᵢ(φ, θ) such that the total power is normalized to unity, i.e.,

$${\tilde{S}}_{i} ( φ , θ ) = \frac{{S}_{i} ( φ , θ )}{{\sum }_{φ , θ} {S}_{i} ( φ , θ )} .$$

The sparse spatial spectrum \tilde{S}ᵢ(φ, θ) is defined as

$${\overline{S}}_{i} ( φ , θ ) = \{ \begin{matrix}{\tilde{S}}_{i} ( φ , θ ) & if ( φ , θ ) ∈ {A}_{i} \\ 0 & else\end{matrix}$$

where Aᵢ is the set of active spatial directions for wireless device i. The set Aᵢ can be obtained from the spatial spectrum in one or more of the following methods that may act to reduce the size of the set due to one or more conditions having to be met:
1—Threshold-based active directions set where the set Aᵢ is formed such that it contains all the spatial directions with received power above a certain fraction of the maximum received power from all directions, i.e.,

$${A}_{i} = \{ ( φ , θ ) \vert {\tilde{S}}_{i} ( φ , θ ) \geq α {max}_{ φ , θ} {\tilde{S}}_{i} ( φ , θ ) \}$$

$$where 0 < α \leq 1$$

is a predetermined threshold.
2—Total power-based active directions set where the set Aᵢ is formed such that it contains the minimum number of spatial directions containing a fraction of the total power, i.e., the set of active directions is the solution to the following optimization problem

min|A_{L}| subject to Σ_{φ,θ}\tilde{S}ᵢ(φ,θ)>δ

where |Aᵢ| denotes the cardinality of the set Aᵢ and 0<δ<1 is a predetermined threshold.

MU-MIMO Pairing Using Directional Spectrum Information

Given the set of candidate MU-MIMO wireless devices (WD); {WD i}ᵢ₌₀^{K-1}, the MU-MIMO pairing algorithm, such as via one or more of processing circuitry 68, processor 70, radio interface 62, pairing unit 32, etc., selects N≤K WDs for MU-MIMO co-scheduling based on the directional spectrum information of the candidate wireless devices 22. The selection is performed in the shared domain where the information of all the candidate wireless devices 22 can be jointly processed. Next, two iterative algorithms that can each be utilized to compute spatial spectrum for performing MU-MIMO pairing decisions are described.

A set containing the indices of the co-scheduled wireless devices 22 after step m of the pairing algorithm as Ψₘ is defined. Furthermore, the set containing the indices of the wireless devices 22 that can still be added to the MU-MIMO group in step m of the algorithm as Ωₘ is defined. The pairing algorithms may start by adding the highest priority wireless devices 22 to the MU-MIMO group, and hence, Ψ₁={0} and Ω₁={1, 2, . . . , K−1}.

Directional Spectrum Correlation-Based Pairing

The directional spectrum correlation metric for testing whether wireless device i and j can be paired together is defined as

$${ρ}_{\tilde{S}}^{( i , j )} = {\sum }_{φ , θ} {\tilde{S}}_{i} ( φ , θ ) {\tilde{S}}_{j} ( φ , θ )$$

where the two wireless devices i and j are pairable if ρ_{\tilde{S}}^{(i,j)}<γ_{S} and γ_{S} is a predetermined threshold. In contrast with the channel orthogonality metric, the metric ρ_{\tilde{S}}^{(i,j)} is evaluated from wideband channel information and does not need averaging over subbands. Furthermore, the spatial spectrum is real-valued and non-negative. Further, the sparse spatial spectrum \tilde{S}ᵢ(φ, θ) may be utilized such as via one or more of processing circuitry 68, processor 70, radio interface 62, pairing unit 32, etc., to compute the directional spectrum correlation metric as

$${ρ}_{\overline{S}}^{( i , j )} = {\sum }_{φ , θ} {\overline{S}}_{i} ( φ , θ ) {\overline{S}}_{j} ( φ , θ )$$

which has lower computational complexity than ρ_{\tilde{S}}^{(i,j)} due to the sparsity of \tilde{S}(φ, θ).

The pairing algorithm starts by adding such as via one or more of processing circuitry 68, processor 70, radio interface 62, pairing unit 32, etc., the wireless device 22 with the highest priority to the MU-MIMO group. At each iteration, the set of candidate wireless devices 22 in a candidate MU-MIMO group for co-scheduling is filtered to remove the wireless devices 22 in the candidate MU-MIMO group that do no pass a pairwise pairing test with all the wireless devices 22 in the MU-MIMO group. Let Πₘ denote the set containing all the wireless devices 22 that passed the pairing tests in step m. The group pairing metric ρ_{\tilde{S}}^{(k)} for wireless devices k∈Πₘ is defined as a function of the pairwise pairing metrics between wireless device k and all the wireless devices in the MU-MIMO group, i.e., ρ_{\tilde{S}}^{(k)}=f({ρ_{\tilde{S}}^{(k,j)}}_{J∈Ψ}_{ₘ}). For example, the following can be selected

$${ρ}_{\tilde{S}}^{( k , j )} = {\sum }_{j ∈ {Ψ}_{m}} {α}_{k , j} {ρ}_{\tilde{S}}^{( k , j )}$$

where α_{k,j} is a scalar that weights the contribution of the MU-MIMO interference of wireless device k on wireless device j and can be selected based on the scheduling priority of the two wireless devices. After evaluating ρ_{\tilde{S}}^{(k)} for all k∈Πₘ, the MU-MIMO group is updated such as via one or more of processing circuitry 68, processor 70, radio interface 62, pairing unit 32, etc., by adding the wireless device with the best group pairing metric ρ_{\tilde{S}}^{(k)} and the set of candidate wireless devices (i.e., candidate MU-MIMO group) for pairing is updated by removing the new paired wireless device and all the wireless devices that failed the pairwise pairing test with all the wireless devices in the MU-MIMO group.

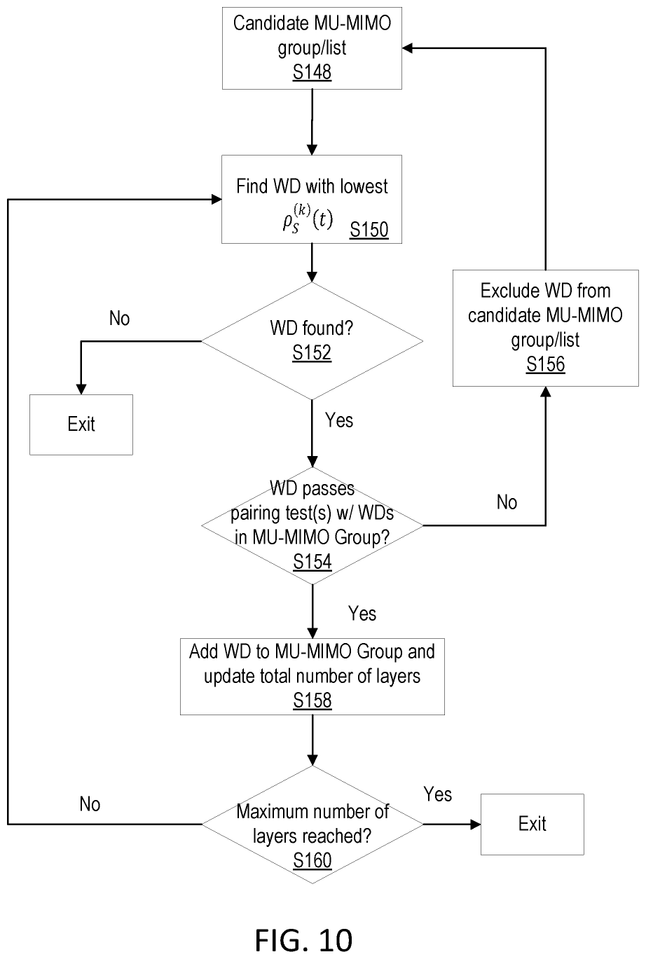

FIG. 10 is a flow diagram of an example of the pairing algorithm. One or more Blocks and/or functions performed by network node 16 may be performed by one or more elements of network node 16, such as by pairing unit 32 in processing circuitry 68, processor 70, radio interface 62, etc. In one or more embodiments, network node 16 such as via one or more of processing circuitry 68, processor 70, pairing unit 32, communication interface 60 and radio interface 62 is configured to determine (Block S148) a candidate MU-MIMO group/list, as described herein. In one or more embodiments, network node 16, such as via one or more of processing circuitry 68, processor 70, pairing unit 32, communication interface 60 and radio interface 62 is configured to find (Block S150) a wireless device with the lowest ρₛ^{(k)}(t), as described herein. In one or more embodiments, network node 16 such as via one or more of processing circuitry 68, processor 70, pairing unit 32, communication interface 60 and radio interface 62 is configured to determine (Block S152) is a wireless device 22 in the candidate MU-MIMO group/list was found, as described herein.

In one or more embodiments, network node 16, such as via one or more of processing circuitry 68, processor 70, pairing unit 32, communication interface 60 and radio interface 62 is configured to, if a wireless devices 22 was found, determine (Block S154) whether the wireless device 22 passes pairing test(s) with wireless devices in the MU-MIMO group, as described herein. However, if the wireless device is not found in Block S150, network node 16 such as via one or more of processing circuitry 68, processor 70, pairing unit 32, communication interface 60 and radio interface 62 is configured to exit the process of FIG. 10. In one or more embodiments, network node 16, such as via one or more of processing circuitry 68, processor 70, pairing unit 32, communication interface 60 and radio interface 62 is configured to, if the wireless device 22 does not pass pairing test(s) in Block S154, exclude (Block S156) the wireless device 22 from the candidate MU-MIMO group/list, as described herein. In one or more embodiments, network node 16, such as via one or more of processing circuitry 68, processor 70, pairing unit 32, communication interface 60 and radio interface 62 is configured to, if the wireless device 22 passes test(s) of Block S154, add (Block S158) the wireless device 22 to the MU-MIMO group and update the total number of layers, as described herein.

In one or more embodiments, network node 16, such as via one or more of processing circuitry 68, processor 70, pairing unit 32, communication interface 60 and radio interface 62 is configured to determine (Block S160) if a maximum number of layers have been reached. If a maximum number of layers have not been reached, network node 16 such as via one or more of processing circuitry 68, processor 70, pairing unit 32, communication interface 60 and radio interface 62 is configured to perform Block S150. However, if the maximum number of layers has been reached, network node 16, such as via one or more of processing circuitry 68, processor 70, pairing unit 32, communication interface 60 and radio interface 62 is configured to exit the process of FIG. 10.

The steps of the algorithm of 10 may written in formula form as:
Initialize Ψ={0}, and Ω={1, 2, . . . , K−1}.
While |Ψ|<N and |Ω|>0
   Initialize Π=Φ where Φ is the empty set
   For each i∈Ω
      Evaluate ρ_{\tilde{S}}^{(i,j)} for all j∈Ψ.
      If ρ_{\tilde{S}}^{(i,j)}<γ_{S} for all j∈Ψ, then Π=Π∪{i}.
   End For
   For each k∈Π, evaluate the group pairing metric ρ_{\tilde{S}}^{(k)}(t)=f({ρ_{\tilde{S}}^{(k,j)}}_{j∈Ψ}).
   Find wireless device p∈Π with the best group pairing metric and higher priority or lower index
   Add wireless device p to the MU-MIMO group, i.e., Ψ=Ψ∪{p}.
   Set Ω=Π−{p}.
End While

In general, the above algorithm can be initialized with Ψ₀={ν}, and Ω={ν+1, . . . , K−1}, where ν represents the highest wireless device request in the queue with data in the buffer to transmit. Once the νth wireless device request is fulfilled, the algorithm is re-initialized such as via one or more of processing circuitry 68, processor 70, radio interface 62, pairing unit 32, etc., with the highest priority wireless device request, ν+k, which is not part of MU group Ψ₀.

Active Spatial Directions-Based Pairing

The active spatial directions overlap metric between the sets of active directions Aᵢ and Aⱼ is defined as

$${ρ}_{A}^{( {A}_{i} , {A}_{j} )} = {\sum }_{φ , θ} {1}_{( φ , θ ) ∈ {A}_{i}} {1}_{( φ , θ ) ∈ {A}_{j}}$$

where 1_{X} denotes the indicator function that returns 1 if X is true, otherwise a 0 is returned. Note that the computational complexity of evaluating ρ_{A}^{(i,j)} is much smaller than that of ρ_{\tilde{S}}^{(i,j)}. The spatial directions overlap test compares ρ_{A}^{(A}^{ᵢ}^{,A}^{ⱼ}⁾ against γ_{A} where γ_{A} is a predetermined threshold and is considered to pass if ρ_{A}^{(A}^{ᵢ}^{,A}^{ⱼ}⁾<γ_{A}.

The active directions-based pairing algorithm iteratively forms the MU-MIMO group such that active spatial directions overlap metric between each added wireless device and all the wireless devices in the MU-MIMO group does not exceed a given threshold. The active directions of the MU-MIMO group at step m is defined as the union of the active directions set of all the paired wireless devices at step m, i.e.,

$${A}_{m}^{M U} = {⋃}_{j ∈ {Ψ}_{m}} {A}_{j}$$

The pairing algorithm starts, such as via one or more of processing circuitry 68, processor 70, radio interface 62, pairing unit 32, etc., by adding the wireless device with the highest priority to the MU-MIMO group, and hence Ψ₁={0}, Ω₁={1, 2, . . . , K−1}, and Aₘ^{MU}=A₀. At each iteration, the set of candidate-wireless devices in the candidate MU-MIMO group for co-scheduling is filtered, such as via one or more of processing circuitry 68, processor 70, radio interface 62, pairing unit 32, etc., to remove the wireless devices whose active directions set do not pass a spatial overlap test with Aₘ^{MU}. Next, the best wireless device that can be added such as via one or more of processing circuitry 68, processor 70, radio interface 62, pairing unit 32, etc., to the MU-MIMO group is added. For example, a “best” wireless device may refer to the wireless device with the highest priority among the filtered wireless devices with the minimum spatial overlap metric with Aₘ^{MU}. The best wireless device is then selected to be added to the MU-MIMO group and the active directions set of the group Aₘ^{MU} is updated to include those of the added wireless device. Furthermore, the set of candidate wireless devices in the candidate MU-MIMO group for pairing is updated by removing the new paired wireless device and all the wireless devices that failed the spatial overlap test with Aₘ^{MU}.

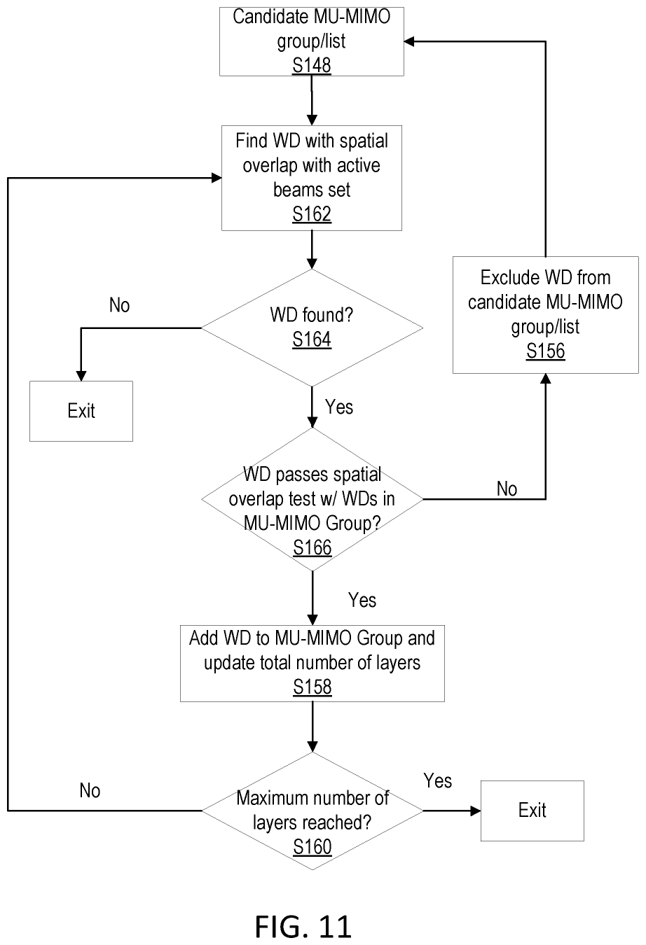

FIG. 11 is a flow diagram of another example pairing algorithm according to the principles of the disclosure. One or more Blocks and/or functions performed by network node 16 may be performed by one or more elements of network node 16 such as by pairing unit 32 in processing circuitry 68, processor 70, radio interface 62, etc. Blocks S148, S156 and S160 in FIG. 11 are as described above with respect to like Block numbers in FIG. 10. In one or more embodiments, network node 16, such as via one or more of processing circuitry 68, processor 70, pairing unit 32, communication interface 60 and radio interface 62 is configured to determine/find (Block S162) a wireless device 22 from the candidate MU-MIMO group/list with spatial overlap with active beams set, as described herein. In one or more embodiments, network node 16, such as via one or more of processing circuitry 68, processor 70, pairing unit 32, communication interface 60 and radio interface 62 is configured to determine (Block S162) if a wireless device 22 was found in Block S162, as described herein. If a wireless devices 22 was not found in Block S162, network node 16 such as via one or more of processing circuitry 68, processor 70, pairing unit 32, communication interface 60 and radio interface 62 is configured to exit the process of FIG. 11.

In one or more embodiments, network node 16, such as via one or more of processing circuitry 68, processor 70, pairing unit 32, communication interface 60 and radio interface 62 is configured to, if a wireless device 22 is found in Block S164, determine (Block S166) whether the wireless device 22 passes a spatial overlap test with wireless devices 22 in the MU-MIMO group, as described herein. In one or more embodiments, network node 16, such as via one or more of processing circuitry 68, processor 70, pairing unit 32, communication interface 60 and radio interface 62 is configured to, if the wireless device 22 does not pass the spatial overlap test, exclude (Block S156) the wireless device 22 from the candidate MU-MIMO group/list. In one or more embodiments, network node 16, such as via one or more of processing circuitry 68, processor 70, pairing unit 32, communication interface 60 and radio interface 62 is configured to, if the wireless device passes the spatial overlap test, add (Block S158) the wireless device to the MU-MIMO group and update the total number of layers, as described herein.

In one or more embodiments, network node 16, such as via one or more of processing circuitry 68, processor 70, pairing unit 32, communication interface 60 and radio interface 62 is configured to perform Block S160 where the process moves to Block S162 if the maximum number of layers are not reached, as described herein. Referring back to Block S164, if a wireless device 22 is not found in Block S162, network node 16, such as via one or more of processing circuitry 68, processor 70, pairing unit 32, communication interface 60 and radio interface 62 is configured to exit the process of FIG. 11.

The steps of the pairing algorithm of FIG. 11 may alternatively be written as:
Initialize Ψ={0}, Ω={1, 2, . . . , K−1}, and A^{MU}=A₀.
While |Ψ|<N and |Ω|>0
   Initialize Π=Φ
   For each i∈Ω
      ▪ If ρ_{A}^{(A}^{ᵢ}^{,A}^{^{MU}}⁾<γ_{A}, then Π=Π∪{i}, i.e., if no collision or if the collision is less than threshold.
   End For
   Find the set of wireless devices B with the minimum spatial overlap metric with A^{MU}, i.e., B={k∈Π|ρ_{A}^{(A}^{ₖ}^{,A}^{^{MU}}⁾≤ρ_{A}^{(A}^{ᵢ}^{,A}^{^{MU}}⁾ for all i∈Π}, i.e., find candidate MU-MIMO group.
   Find wireless device p; the best wireless device to be added to the MU-MIMO group; i.e., the wireless device with the highest priority in the set B
   Add UE p to the MU-MIMO group, i.e., Ψ=Ψ∪{p}
   Set Ω=Π−{p}, A^{MU}=A^{MU}∪Aₚ
End While

In general, the above algorithm performed, such as via one or more of processing circuitry 68, processor 70, radio interface 62, pairing unit 32, etc., can be initialized with Ψ₀={ν}, Ω={ν+1, . . . , K−1} and A^{MU}=A_{ν}, where ν represents the highest wireless device request in the queue with data in the buffer to transmit. Once the νth wireless device request is fulfilled, the algorithm is re-initialized with the highest priority wireless device request, ν+k, which is not part of MU group Ψ₀.

Performance Evaluation

The performance of the MU-MIMO grouping algorithms described herein are illustrated using system-level simulations. In particular, a 5G cellular system with bandwidth 30 MHz and carrier frequency 3.5 GHz is simulated. The system operates in time division duplex mode where the Downlink/Uplink timeslot pattern is 3/1. A 7-site deployment scenario is considered where each site has 3 cells, the inter-site distance is equal to 500 m and the wireless devices 22 are dropped randomly in the simulation area. The 5G SCM Urban Macro channel model with NLOS communication is used in this simulation. The antenna configuration at network node 16 is the AAS AIR 6488 (4×89) configuration and each wireless device 22 is equipped with 2 omni-directional receive antennas. The traffic model for the downlink is selected as full buffer. The legacy channel-correlation based pairing scheme is used as a benchmark.

In this scheme, wireless devices 22 are added to the MU-MIMO group sequentially based on their scheduling priority given that they pass a pairwise channel orthogonality test with all the wireless devices that are already in the MU-MIMO group. The channel orthogonality test is performed using one sample of the channel response and the pairing test threshold γ_{H}=0.15 was selected such that it yields the maximum cell throughput (through simulations). The periodgram spectrum estimator used is a DFT-based spatial grid with only 8 horizontal beam directions and 4 vertical beam directions. On the other hand, the Capon spectrum estimator used in the simulations utilized a tracked subspace of rank R=4 and a two dimensional uniformly spaced spatial grid of spacing 5° in the azimuth and elevation directions, i.e., the two-dimensional spatial grid has 25 horizontal and 13 vertical grid points where the azimuth angle extends from −60° to 60° and the elevation angles extends from −30° to 30°. The threshold for determining whether a beam is active or not was set to α=0.4. The pairing threshold for the pairing algorithms was selected as γ_{S}=0.4 for the peridogram spectrum and γ_{S}=0.55 for the Capon spatial spectrum and the threshold for the active directions overlap test was γ_{A}=0, i.e., no overlap in the active directions is allowed.

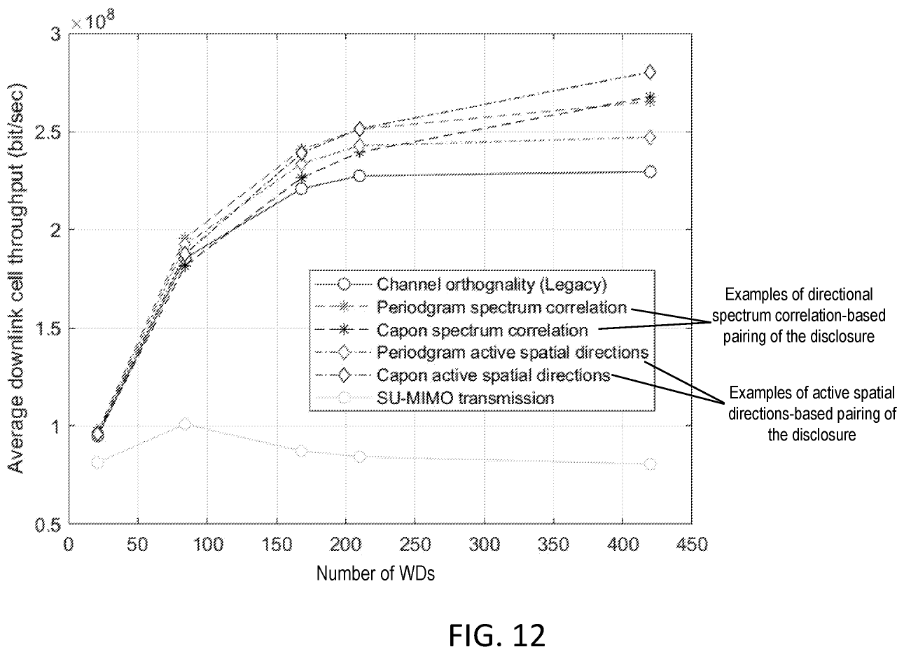

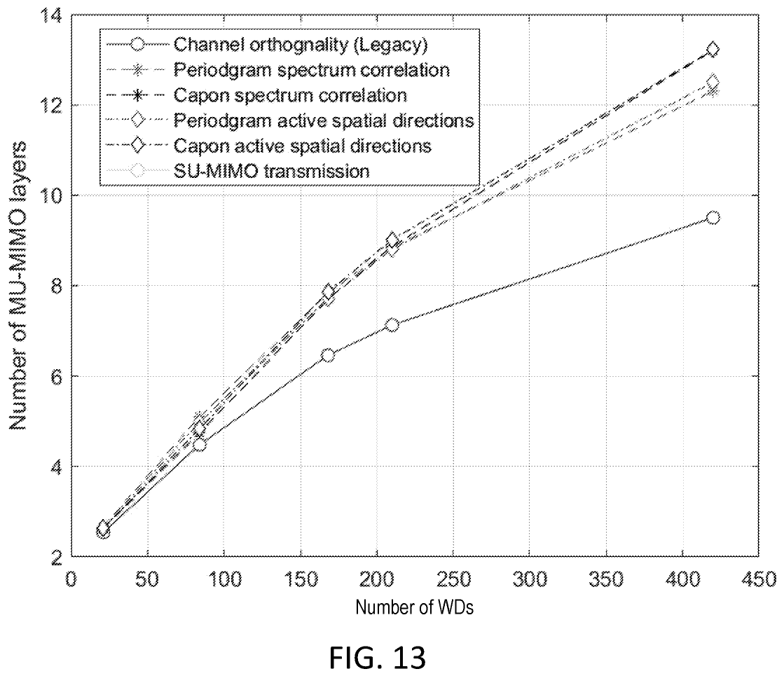

FIG. 12 is a diagram of an example of the average downlink cell throughput versus the number of wireless devices 22 in the simulation area. As illustrated in FIG. 12, the pairing algorithms described herein in accordance with the principles of the disclosure provide around 20% gain over legacy channel orthogonality-based MU-MIMO grouping. FIG. 13 is a diagram of the average number of multiplexed MU-MIMO layers. As illustrated in FIG. 13, the algorithms described herein in accordance with the principles of the disclosure have a larger number of multiplexed MU-MIMO layers compared to legacy MU-MIMO transmission. The gain in cell throughput gain provided by algorithms described herein in accordance with the principles of the disclosure, as illustrated in FIG. 12, is not only due to the larger number of multiplexed layers, but also due to the ability of the algorithms to properly select the wireless devices 22 that can be paired together. This is illustrated in FIG. 13 where the average number of multiplexed layers of the legacy algorithm increased from 7 to 9.5 layers when the number of wireless devices 22 in the 21 cells increased from 220 wireless devices 22 to 440 wireless devices 22 while the corresponding cell throughput of the legacy algorithm illustrated in FIG. 12 did not increase. In contrast, the increase in the throughput of the algorithms described herein in accordance with the principles of the disclosure when the number of available users increases due to their ability to exploit multiuser diversity is illustrated in FIG. 12.

Therefore, one or more embodiments described herein utilize low-complexity wideband directional spectrum for MU-MIMO pairing. In addition to using the periodogram for computing the spatial spectrum, subspace tracking is advantageously utilized to provide an iterative estimate of the signal space of the wireless device 22 channel to be used in computing the Capon spatial spectrum with low computational complexity. The spatial spectrum is utilized for performing MU-MIMO pairing decisions by computing a wideband correlation coefficient of the spatial spectrum to determine the spatial separability of the wireless devices 22. In addition, a reduced complexity pairing algorithm is also provided that utilizes the significant spatial directions in the spatial spectrum and selects the wireless devices from a candidate MU-MIMO group to includes in the MU-MIMO group for paring if the spatial overlap between the wireless devices is sufficiently small.

Also, one or more embodiments provide one or more of the following advantages:
The subspace tracking based Capon spectral estimation method can directly compute the spatial spectrum with low computational complexity that advantageously grows linearly in the number of antennas at the base station.
The directional spectrum-based MU-MIMO grouping algorithms provide significant gain in cell throughput compared to legacy channel orthogonality-based MU-MIMO group selection.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviation Explanation

### MU-MIMO Multi-User Multiple Input Multiple Output

PASTd Projection Approximation Subspace Tracking with deflation

### SU-MIMO Single-User Multiple Input Multiple Output

### UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node, comprising:
processing circuitry configured to:
estimate a spatial spectrum associated with a plurality of wireless devices;
determine active spatial directions for the plurality of wireless devices based at least on the estimated spatial spectrum; and
determine Multiple User-Multiple Input Multiple Output, MU-MIMO, pairing based at least on the determined active spatial directions.

2. The network node of claim 1, wherein the estimate of the spatial spectrum includes:
computing an instantaneous spatial spectrum; and
temporal filtering of the instantaneous spatial spectrum, the estimated spatial spectrum being based at least on the temporal filtering.

3. The network node of claim 1, wherein the estimate of the spatial spectrum includes:
estimating a covariance matrix of a channel by tracking a subset of eigen vectors of the covariance matrix, the estimate of the spatial spectrum being based on the estimated covariance matrix.

4. The network node of claim 3, wherein the subset of eigen vectors are dominant eigen vectors of the covariance matrix that are associated with higher eigen values than the remaining eigen vectors of the covariance matrix.

5. The network node of claim 1, wherein each of the active spatial directions for the plurality of wireless devices meets a predefined received power threshold.

6. The network node of claim 1, wherein the active spatial directions correspond to a minimum number of spatial directions that meet a predefined received power threshold.

7. The network node of claim 1, wherein the processing circuitry is further configured to:
determine a pairwise spectrum correlation metric for each wireless device of the plurality of wireless devices with respect to each of the plurality of wireless devices, the plurality of wireless devices corresponding to a candidate MU-MIMO group;
determine whether each pairwise spectrum correlation metric meets a predefined threshold; and
add each wireless device associated with the pairwise spectrum correlation metric meeting the predefined threshold to a MU-MIMO group of wireless devices, the determined MIMO pairing being based at least on the MU-MIMO group of wireless devices.

8. The network node of claim 7, wherein the pairwise spectrum correlation metric is non-negative and based at least on wideband channel information.

9. The network node of claim 7, wherein the processing circuitry is further configured to:
determine a group paring metric for each wireless device in the candidate MU-MIMO group with respect to the MU-MIMO group of wireless devices; and
select a wireless device to include in a MU-MIMO group of wireless devices based on the group pairing metric, the determined MIMO pairing being based at least on the MU-MIMO group.

10. The network node of claim 1, wherein the processing circuitry is further configured to:
determine a spatial directions overlap metric for each wireless device of the plurality of wireless devices with respect to a MU-MIMO group of wireless devices, the plurality of wireless devices corresponding to a candidate MU-MIMO group;
determine whether the spatial directions overlap metric for each wireless device meets a predefined criteria; and
add each wireless device associated with the spatial directions overlap metric meeting the predefined criteria to the MU-MIMO group of wireless devices, the determined MIMO pairing being based at least on the MU-MIMO group of wireless devices.

11. The network node of claim 10, wherein the processing circuitry is further configured to select a wireless device to include in the MU-MIMO group of wireless devices based on a respective priority of each wireless device in the candidate MU-MIMO group, the determined MIMO pairing being based at least on the MU-MIMO group.

12. A method implemented by a network node, the method comprising:
estimating a spatial spectrum associated with a plurality of wireless devices;
determining active spatial directions for the plurality of wireless devices based at least on the estimated spatial spectrum; and
determining Multiple User-Multiple Input Multiple Output, MU-MIMO, pairing based at least on the determined active spatial directions.

13. The method of claim 12, wherein the estimate of the spatial spectrum includes:
computing an instantaneous spatial spectrum; and
temporal filtering of the instantaneous spatial spectrum, the estimated spatial spectrum being based at least on the temporal filtering.

14. The method of claim 12, wherein the estimate of the spatial spectrum includes:
estimating a covariance matrix of a channel by tracking a subset of eigen vectors of the covariance matrix, the estimate of the spatial spectrum being based on the estimated covariance matrix.

15. The method of claim 14, wherein the subset of eigen vectors are dominant eigen vectors of the covariance matrix that are associated with higher eigen values than the remaining eigen vectors of the covariance matrix.

16. The method of claim 12, wherein each of the active spatial directions for the plurality of wireless devices meets a predefined received power threshold.

17. The method of claim 12, wherein the active spatial directions correspond to a minimum number of spatial directions that meet a predefined received power threshold.

18. The method of claim 12, further comprising:
determining a pairwise spectrum correlation metric for each wireless device of the plurality of wireless devices with respect to each of the plurality of wireless devices, the plurality of wireless devices corresponding to a candidate MU-MIMO group;
determining whether each pairwise spectrum correlation metric meets a predefined threshold; and
adding each wireless device associated with the pairwise spectrum correlation metric meeting the predefined threshold to a MU-MIMO group of wireless devices, the determined MIMO pairing being based at least on the MU-MIMO group of wireless devices.

19. The method of claim 18, wherein the pairwise spectrum correlation metric is non-negative and based at least on wideband channel information.

20. The method of claim 18, further comprising:
determining a group paring metric for each wireless device in the candidate MU-MIMO group with respect to the MU-MIMO group of wireless devices; and
selecting a wireless device to include in a MU-MIMO group of wireless devices based on the group pairing metric, the determined MIMO pairing being based at least on the MU-MIMO group.

21. The method of claim 12, further comprising:
determining a spatial directions overlap metric for each wireless device of the plurality of wireless devices with respect to a MU-MIMO group of wireless devices, the plurality of wireless devices corresponding to a candidate MU-MIMO group;
determining whether the spatial directions overlap metric for each wireless device meets a predefined criteria; and
adding each wireless device associated with the spatial directions overlap metric meeting the predefined criteria to the MU-MIMO group of wireless devices, the determined MIMO pairing being based at least on the MU-MIMO group of wireless devices.

22. The method of claim 21, further comprising selecting a wireless device to include in the MU-MIMO group of wireless devices based on a respective priority of each wireless device in the candidate MU-MIMO group, the determined MIMO pairing being based at least on the MU-MIMO group.
